(19) United States
(12) Patent Application Publication
(10) Pub. No.: US 2017/0083995 A1
(43) Pub. Date: Mar. 23, 2017

(54) SYSTEM AND METHOD FOR GENERATING JURY INSTRUCTIONS

(71) Applicant: Richard K. Oliver, Houston, TX (US)

(72) Inventor: Richard K. Oliver, Houston, TX (US)

(21) Appl. No.: 14/857,483

(22) Filed: Sep. 17, 2015

(51) Int. Cl. G06Q 50/26; G06Q 10/10; G06Q 50/18

(52) U.S. Cl. CPC G06Q 50/26; G06Q 50/18; G06Q 10/10

(57) ABSTRACT

A method for generating jury instructions employs, in the preferred embodiment, a jury instruction wizard system that guides a user through a series of case questions through a questionnaire interface to obtain pertinent data related to a selected court case while communicating with a reference database having stored thereon a plurality of standardized definitions and jury instructions, a plurality of preset decision tree rules which are employed to guide and optimize the question asking/case data retrieval, as well as a relational chart which includes information that relates together relevant charges, mental states, defenses and other pertinent categories of data. Through such interactions, the jury instructions wizard system produces an output defining a set of definitions and jury instructions which are relevant to the data received concerning the selected court case.

### BRIEF DESCRIPTION OF THE DRAWINGS

FIG. 1 is a block diagram showing the general operation of a system and method for generating jury instructions in accordance with the present invention.

FIG. 2 shows an exemplary questionnaire interface screen shot for an offense selection query of a system and method for generating jury instructions in accordance with the present invention.

FIG. 3A shows the beginning of the process through which jury outputs are compiled and output in a system and method for generating jury instructions in accordance with the present invention.

FIG. 3B shows the middle of the process through which jury outputs are compiled and output in a system and method for generating jury instructions in accordance with the present invention.

FIG. 3C shows the end of the process through which jury outputs are compiled and output in a system and method for generating jury instructions in accordance with the present invention.

### DETAILED DESCRIPTION OF THE INVENTION

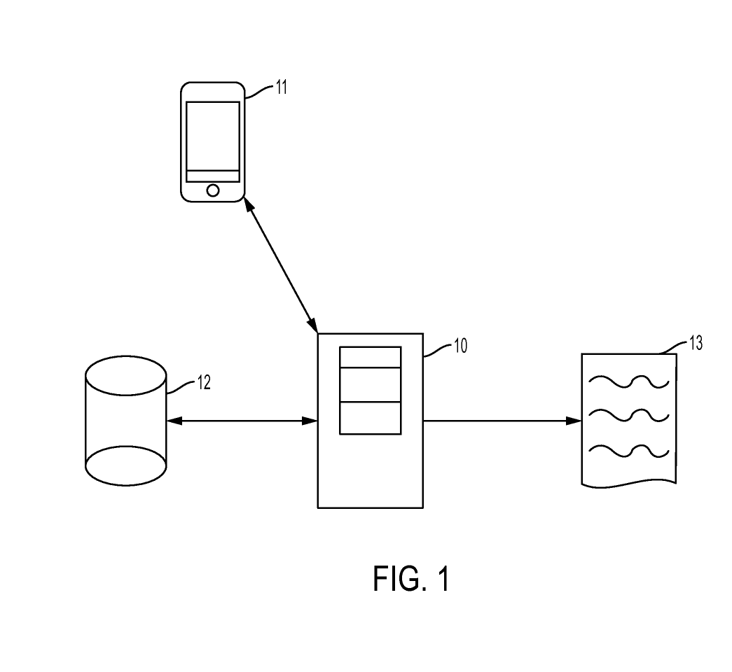

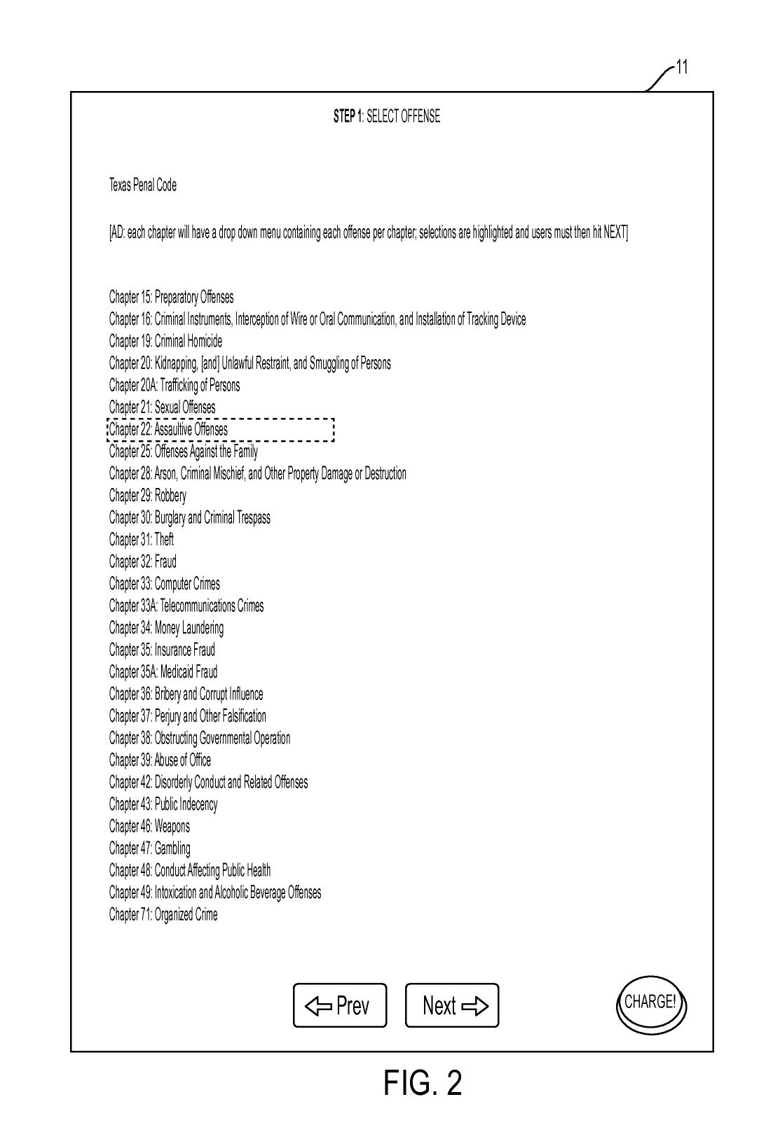

Referring now to the drawings and, in particular, FIGS. 1 and 2, a method for generating jury instructions employs, in the preferred embodiment, a jury instruction wizard system 10 that guides a user through a series of case questions through a questionnaire interface 11 to obtain pertinent data related to a selected court case while communicating with a reference database 12 having stored thereon a plurality of standardized definitions and jury instructions for a legal jurisdiction, a plurality of preset decision tree rules which are employed to guide and optimize the question asking/case data retrieval, as well as a relational chart which includes information that details all potential charges, elements and defenses in a selected jurisdiction and associates each charge, element and defense with all relevant definitions. Through such interactions, the jury instructions wizard system 10 produces an output defining a set of definitions and jury instructions (collectively, jury outputs) 13 which are relevant to the data received concerning the selected court case.

In one embodiment, it is contemplated that the jury instruction wizard system 10 defines a computer system which includes a processor and non-volatile memory, with the non-volatile memory containing instructions embodied as a wizard software module that enables the processor to create and operate or just operate the questionnaire interface 11 so as to guide a user through a series of case questions. Through the user supplied responses to the case questions, case data inputs related to a selected court case, such as a charge selections evidentiary selections, are generated. Such case data inputs are processed in real time, allowing the wizard software module to use the case data inputs along with the data stored in the reference database 12 to optimize subsequent case questions to be posed through the questionnaire interface 11 as well as to retrieve and subsequently output an appropriate set of desired jury outputs 13. In this regard, the questionnaire interface 11 enables the jury instruction wizard system 10 to obtain case data from a user for use in retrieving the desired jury outputs 13.

At its core, the jury instruction wizard system 10 is operative to generate a schedule of questions and pose questions from the schedule of questions one at a time through the questionnaire interface 11. It is contemplated that in some embodiments, the jury instruction wizard system 10 provides a plurality of potential responses from which the user can select for each posed question through the questionnaire interface 11, with the potential responses corresponding to various decision tree rules in the database 12. Advantageously, this style of response selection process allows the jury instruction wizard system 10 to operate in a decision tree format wherein each of the various selections may cause the jury instruction wizard system 10 to selectively skip subsequent scheduled questions, add questions to the schedule of questions, or both (on a question by question basis) based on the feedback of decision tree rules. In addition, it is appreciated that once a selection is made for a charge and any applicable culpable mental state, the jury instruction wizard system 10 is able to proceed through the schedule of questions by simply answering yes or no to each question.

In alternate embodiments, the questionnaire interface 11 may allow a user to directly enter the text for some or all of the responses, with the jury instruction wizard system 10 then either matching the entered response to a listing of potential responses (which correspond to decision tree rules, so as to maintain the decision tree format of questions) or directly using the entered response when generating the jury instructions 13 (which may be desirable for dates, names, or other information which may be (1) unique to a case, (2) not pertinent to optimizing subsequent scheduled questions, and/or (3) desirable to incorporate into one or more of the desired jury outputs 13 to be generated).

In typical embodiments, the jury instructions wizard system 10 is embodied on a server computer system which additionally includes a networking interface and the questionnaire interface 11 is embodied on a discrete, remote computer system which includes a processor, non-volatile memory, and a networking interface. In such embodiments, the jury instructions wizard system 10 is operative to provide the questionnaire interface 11 on the remote computer system by communicating data electronically through a computer network, such as the Internet, through their respective networking interfaces.

It is appreciated, however, that in alternate embodiments, the jury instructions wizard system 10 may be present on the remote computer system and provide the questionnaire interface 11.

In any embodiment, the database 12 may be housed on the first computer system with the jury instructions wizard system 10 or accessed on a discrete computer system, whether a second computer system along with the questionnaire interface 11 or some separate computer system, through the networking interface of said first computer system.

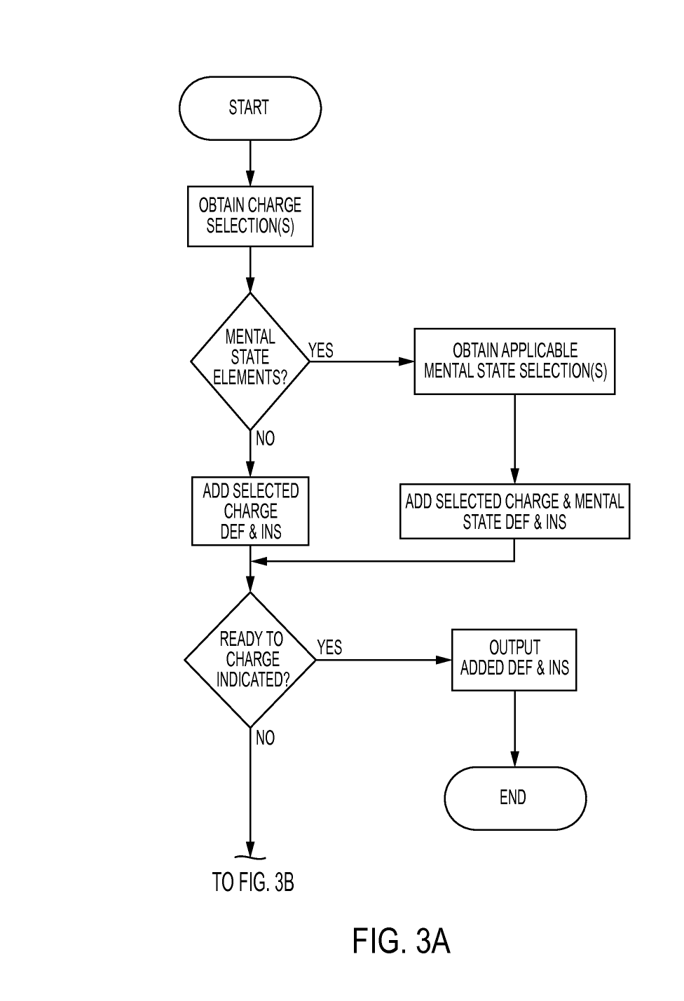

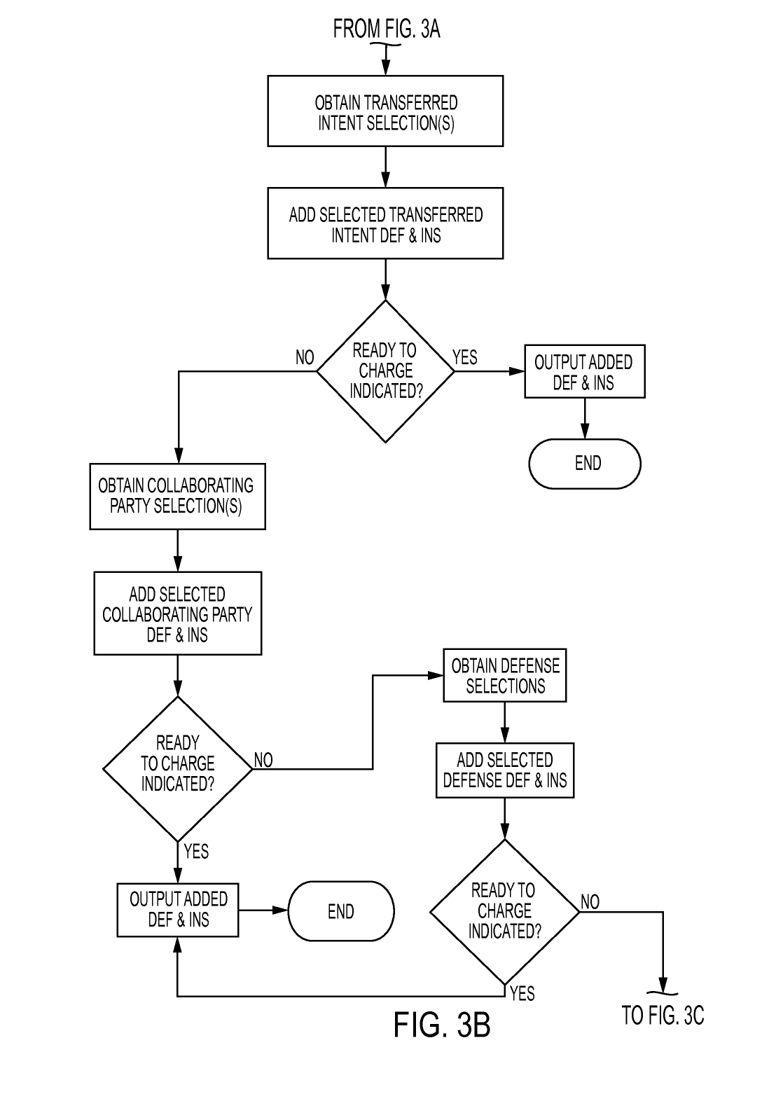

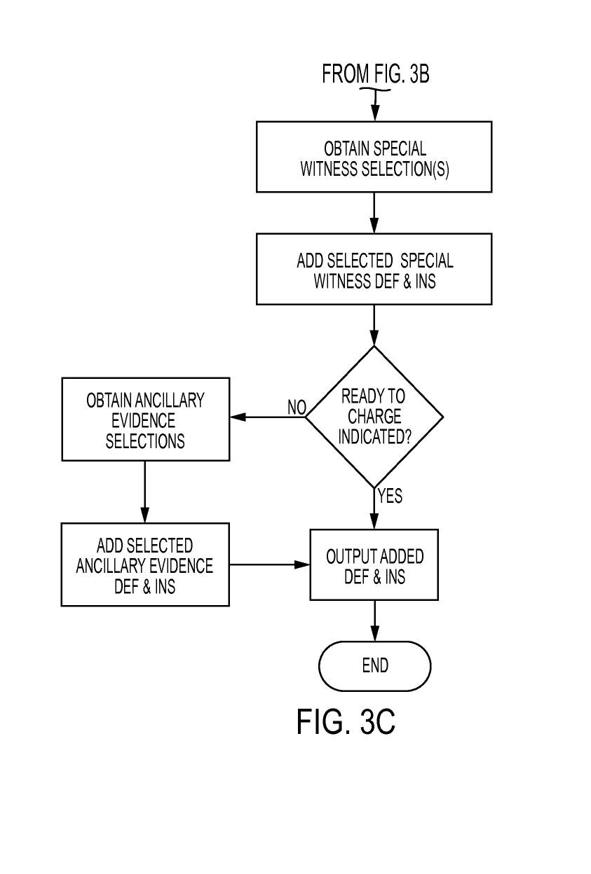

Referring now to FIGS. 3A, 3B, and 3C, the process through which a jury output is generated for a selected court case begins with a charge selection being obtained through the questionnaire interface. This step is illustrated in FIG. 2 an captured in Step 1 (including all subparts; i.e. 1A) in the example between paragraphs 23 and 24 below (the material between these paragraphs details an exemplary interview through which relevant information is obtained in accordance with the present invention). With the charge selection obtained, the jury instructions wizard system next automatically determines whether there are any culpable mental states involved with the charge selected (i.e. general intent offenses). An illustration of this is seen in Step 2 (including all subparts) in the example between paragraphs 23 and 24. If there are no culpable mental states, the system adds the definitions and instructions relevant to the charge selected to a running queue and avails the user a ready to charge option. If the ready to charge option is selected, the system outputs the queued definitions and instructions as jury outputs and terminates the process. If the ready to charge option is not selected, the system moves on by presenting the next category of questions through the questionnaire interface.

If there are culpable mental states, the wizard system obtains through the questionnaire interface each culpable mental state at issue and adds the definitions and instructions applicable to the selected charge and culpable mental state(s) to the running queue. The ready to charge option is availed, allowing the user to either have the system produce the jury outputs and terminate or move on to the next category.

In the event the ready to charge option is not selected, the system next obtains through the questionnaire interface selections related to transferred intent and adds to the running queue (which at this point may have charge related selections only or charge and mental state selections) the definitions and jury instructions relevant to the any transferred intent selection. An illustration of this is seen in Step 3 (including all subparts) in the example between paragraphs 23 and 24. The ready to charge option is then availed once again.

Provided the ready to charge option is not selected, the system next obtains collaborating party selections through the questionnaire interface. Selections are added to the running queue and the ready to charge option is availed. An illustration of this is seen in Step 6 in the example between paragraphs 23 and 24.

The system is operative to next obtain selections on defenses through the questionnaire. Any selections are added to the running queue and the ready to charge option is once again availed to the user through the questionnaire interface. An illustration of this is seen in Steps 4, 5, 7, and 9-15 (including all subparts) in the example between paragraphs 23 and 24.

Following defenses, the wizard system moves to obtaining through the wizard special witness selections. For example, the jury instructions wizard system may seek to obtain a selection which indicates whether any witness(es): (1) was offered or received money or special treatment; (2) was subject to any pressure or threat; (3) make any inconsistent statement with testimony; (4) had been previously convicted of a crime involving dishonesty; (5) have a general reputation for truthfulness or dishonesty; (6) is a law enforcement official; (7) was an expert witness; (8) was an accomplice or informant; (9) was a child; (10) was the defendant; and (11) spoke to a lawyer. As with previous categories, selections are added to the running queue and the ready to charge option is availed. An illustration of this is seen in Step 17 in the example between paragraphs 23 and 24.

The system next obtains selections concerning ancillary evidence and adds the selected issues to the running queue. The entire running queue is then outputs as jury outputs and the process terminates. An illustration of this is seen in Step 16 (including all subparts) in the example between paragraphs 23 and 24.

Advantageously, by adding definitions and instructions to the running queue, the system is able to reduce overall computer resource consumption relative to compiling all definitions and instructions once all of the user selections have been obtained. This also enables the final jury outputs to be output and the process terminated at substantially any point using the same software functions (not requiring different processor instructions to terminate at various points in the process.

It is appreciated that in alternate embodiments, the jury instructions wizard system and reference database may include a plurality of selectable jurisdictions such that a user can select a desired jurisdiction prior to going through the process through which a jury output is generated for a selected court case or the process through which specialized evidentiary instructions can be generated.

It is contemplated that the jury instructions wizard system and reference database may be alternatively be customized to generate jury instructions for other aspects of a selected court case or to generate instructions relevant to civil court claims, defenses and damages.

In one embodiment, the jury instructions wizard system and reference database may include standardized jury charge objections along with the standardized definitions and jury instructions for a legal jurisdiction and the plurality of preset decision tree rules and a relational chart includes information that details all potential jury charge objections in a selected jurisdiction, associated with each charge, element, defense, and definition.

An example of the manner in which the jury instructions wizard system obtains pertinent data to related to a selected court case and adds definitions and instructions to a running queue is as follows:

### Step 1: Select Offense

### Texas Penal Code

[each chapter will have a drop down menu containing each offense per chapter; selections are highlighted and users must then hit NEXT]

### Chapter 15: Preparatory Offenses

### Chapter 16: Criminal Instruments, Interception of Wire or Oral Communication, and Installation of Tracking Device

### Chapter 19: Criminal Homicide

Chapter 20: Kidnapping, [and] Unlawful Restraint, and Smuggling of Persons

### Chapter 20A: Trafficking of Persons

### Chapter 21: Sexual Offenses

### Chapter 22: Assaultive Offenses

### Chapter 25: Offenses Against the Family

### Chapter 28: Arson, Criminal Mischief, and Other Property Damage or Destruction

### Chapter 29: Robbery

### Chapter 30: Burglary and Criminal Trespass

### Chapter 31: Theft

### Chapter 32: Fraud

### Chapter 33: Computer Crimes

### Chapter 33A: Telecommunications Crimes

### Chapter 34: Money Laundering

### Chapter 35: Insurance Fraud

### Chapter 35A: Medicaid Fraud

### Chapter 36: Bribery and Corrupt Influence

### Chapter 37: Perjury and Other Falsification

### Chapter 38: Obstructing Governmental Operation

### Chapter 39: Abuse of Office

### Chapter 42: Disorderly Conduct and Related Offenses

### Chapter 43: Public Indecency

### Chapter 46: Weapons

### Chapter 47: Gambling

### Chapter 48: Conduct Affecting Public Health

### Chapter 49: Intoxication and Alcoholic Beverage Offenses

### Chapter 71: Organized Crime

### Step 1A: Select Offense

### Chapter 22: Assaultive Offenses

### §22.01: Assault

### §22.011: Sexual Assault

### §22.02: Aggravated Assault

### §22.021: Aggravated Sexual Assault

§22.04: Injury to a child, Elderly Individual, Or Disabled Individual

### §22.041: Abandoning Or Endangering Child

### §22.05: Deadly Conduct

### §22.07: Terroristic Threat

### §22.08: Aiding Suicide

§22.09: Tampering with Consumer Product

### §22.10: Leaving a Child in a Vehicle

### §22.11: Harassment By Persons in Certain Correctional Facilities; Harassment of Public Servant

### §22.01: Assault

### Step 2: How was the Offense Charged in the Indictment/Information? [Select One]

(1) Intentionally, knowingly, or recklessly caused bodily injury to the complainant; or
(2) Intentionally or knowingly threatened with complainant with imminent bodily injury; or
(3) Intentionally or knowingly caused physical contact with the complainant when your client knew or should have reasonably believed that the complainant would regard the contact as offensive or provocative.
   NOTE: Subsections (1)-(3) describe separate and distinct criminal acts. A jury charge that includes more than a single alleged criminal act should not be submitted in the disjunctive unless the jury is informed/instructed that it must be unanimous about each specific act it believes was committed, if any. Practitioners should create separate instructions with respect to each distinct criminal act charged.
   [If (1) above is chosen—users will need to answer Step 2A. If users select (2) or (3) above go directly to Step 3]

### Step 2A: Which Culpable Mental States were Alleged in the Information?

### [SELECT ALL THAT APPLY]

(1) Intentionally

(2) Knowingly

(3) Recklessly

[Include ONLY the definition of each selected culpable mental state from DEFINITIONS to the CHARGE]

### Step 3: Does the State's Evidence Suggest Your Client Intended to Assault Complainant A, but Ended Up Assaulting Complainant B Instead?

### NO

### YES

[If user answer YES—add “Transferred Intent: Different Person” instruction from CHARGE BANK to CHARGE]
[The “Charge” button appears beginning on this page; pushing this button will take users directly to the CHARGE—the CHARGE will only include the proposed instructions triggered by questions asked to this point]

### Step 3A: Does the State's Evidence Suggest Your Client Intended to Commit Assault but Instead Committed a Different Criminal Offense Altogether?

[In embodiments for defense attorneys or if the user has indicated to the wizard that defense instructions are being created, it is contemplated that this step may be skipped]

### NO

### YES

[If user answer YES—add “Transferred Intent: Different Offense” from CHARGE BANK to CHARGE]

### Step 4: Did Your Client Intend to Make Contact with the Complainant, but not Commit an Assault that Caused “Bodily Injury?”

### NO

### YES

[if user answers YES—add MISTAKE OF FACT from CHARGE BANK to CHARGE]

### Step 5: Was Your Client Accused of Acting or Participating as a Party to the Assault?

### NO

### YES

[if YES, add PARTIES TO OFFENSES from DEFINITIONS to CHARGE]
[If YES, add CRIMINAL RESPONSIBILITY FOR CONDUCT OF ANOTHER from CHARGE BANK to CHARGE]

### [if YES, go to STEP 5A]

### [if NO, go to STEP 6]

### Step 5A: Is an Aspect of Your Defense an Argument (Supported by the Evidence) that Your Client was Merely Present at the Place where the Assault Took Place?

### NO

### YES

[if YES add MERE PRESENCE instruction from CHARGE BANK to CHARGE]

### Step 5B: Is an Aspect of Your Defense an Argument (Supported by the Evidence) that Although Your Client Knew an Assault would Take Place, he/she Took No Active Part in the Commission of the Offense?

### NO

### YES

[if YES add MERE KNOWLEDGE instruction from CHARGE BANK to CHARGE]

### Step 5C: Were any of the Other Charged Parties Called to Testify Against Your Client by the State?

### NO

### YES

[if YES, add ACCOMPLICE from DEFINITIONS to CHARGE]

### [if YES, add ACCOMPLICE WITNESS TESTIMONY—ACCOMPLICE AS A

MATTER OF LAW from CHARGE BANK to CHARGE]

[if YES, add ACCOMPLICE AS A MATTER OF LAW APPLICATION from CHARGE BANK to CHARGE]

### Step 6: Based on the Evidence would it have been Possible for the State to Charge any of their Testifying Witnesses with the Same Offense for which Your Client was Charged?

### NO

### YES

[if YES, add ACCOMPLICE from DEFINITIONS to CHARGE]
[if YES, add ACCOMPLICE WITNESS TESTIMONY—ACCOMPLICE STATUS SUBMITTED TO JURY from CHARGE BANK to CHARGE]
[if YES, add ACCOMPLICE AS A MATTER OF FACT APPLICATION from CHARGE BANK to CHARGE]

### Step 7: Did the Complainant, by Words or Actions, Encourage or Provoke Your Client to Commit the Assault?

### NO

### YES

[if YES add CONSENT from CHARGE BANK to CHARGE]

### Step 8: Does Your Client Claim that while he/she Did Threaten the Complainant he/she Did not Assault them (i.e. Cause Bodily Injury)?

### NO

### YES

[if YES add LESSER INCLUDED OFFENSE from CHARGE BANK]
[if YES add LESSER INCLUDED OFFENSE from DEFINITIONS]
[if YES add BENEFIT-OF-THE-DOUBT from CHARGE BANK]
[if YES add §22.01(a)(2) from OFFENSES AND ELEMENTS]

### Step 9: Did Your Client Claim the Assault was Self-Defense?

### NO

### YES

[if YES add SELF-DEFENSE: NON-DEADLY FORCE from CHARGE BANK to CHARGE]

### [if YES go to STEP 9A]

### [if NO go to STEP 10]

### Step 9A: Did Your Client have a Right to be at the Location where the Acts Constituting Self-Defense Occurred?

### NO

### YES

[if YES add FAILURE TO RETREAT from CHARGE BANK to CHARGE]

### Step 9B: Did Your Client Believe or have Reason to Believe the Complainant Unlawfully and with Force, Entered or Attempted to Enter his Occupied Habittation?

### NO

### YES

[if YES add SELF-DEFENSE: PRESUMPTION OF REASONABLENESS from CHARGE BANK to CHARGE]

### Step 9C: Did Your Client Believe or have Reason to Believe the Complainant Unlawfully and with Force, Entered or Attempted to Enter his Vehicle?

### NO

### YES

[if YES add SELF-DEFENSE: PRESUMPTION OF REASONABLENESS from CHARGE BANK to CHARGE]

### Step 9D: Did Your Client Believe or have Reason to Believe the Complainant Unlawfully and with Force, Entered or Attempted to Enter his Place of Business or Employment?

### NO

### YES

[if YES add SELF-DEFENSE: PRESUMPTION OF REASONABLENESS from CHARGE BANK to CHARGE]

### Step 9E: Did Your Client Believe or have Reason to Believe the Complainant Unlawfully and with Force, Removed or Attempted to Remove Your Client from his Habitation?

### NO

### YES

[if YES add SELF-DEFENSE: PRESUMPTION OF REASONABLENESS from CHARGE BANK to CHARGE]

### Step 9F: Did Your Client Believe or have Reason to Believe the Complainant Unlawfully and with Force, Removed or Attempted to Remove Your Client from his Vehicle?

### NO

### YES

[if YES add SELF-DEFENSE: PRESUMPTION OF REASONABLENESS from CHARGE BANK to CHARGE]

### Step 9G: Did Your Client Believe or have Reason to Believe the Complainant Unlawfully and with Force, Removed or Attempted to Remove Your Client from his Place of Business or Employment?

### NO

### YES

[if YES add SELF-DEFENSE: PRESUMPTION OF REASONABLENESS from CHARGE BANK to CHARGE]

### Step 9H: Did Your Client Believe or have Reason to Believe the Complainant was Committing or Attempting to Commit any of the Following Offenses: Aggravated Kidnapping, Murder, Sexual Assault, Aggravated Sexual Assault Robbery, or Aggravated Robbery?

### NO

### YES

[if YES add SELF-DEFENSE: PRESUMPTION OF REASONABLENESS from CHARGE BANK to CHARGE]

### Step 9I: Is the State Claiming Your Client Provoked the Complainant?

### NO

### YES

[if YES add SELF-DEFENSE: PROVOCATION from CHARGE BANK to CAHRGE]

### [if YES go to STEP 9I-1]

### [if NO go to STEP 9J]

### Step 9I-1: Is Part of Your Defense an Argument that Even Though there is Evidence Suggesting Your Client Provoked the Complainant, he Abandoned the Encounter, or Clearly Communicated his Intent to Abandon the Encounter?

### NO

### YES

[if YES add SELF-DEFENSE: ABANDONMENT from CHARGE BANK to CHARGE]

### Step 9I-2: Is Part of Your Defense an Argument that Even Though there is Evidence Suggesting Your Client Provoked the Complainant, he Abandoned the Encounter, or Clearly Communicated his Intent to Abandon the Encounter, and Despite Your Client's Efforts to Abandon the Encounter, the Complainant Continued to Pursue the Encounter which Forced Your Client to Act in Self-Defense?

### NO

### YES

[if YES add SELF-DEFENSE: ABANDONMENT-PURSUIT from CHARGE BANK to CHARGE]

### Step 9J: Did Your Client Feel he/she was in Danger of being Assaulted by Multiple Assailants (any One or all of them)?

### NO

### YES

[if YES add SELF-DEFENSE: NON-DEADLY FORCE from CHARGE BANK to CHARGE]
[if YES add SELF-DEFENSE: MULTIPLE ASSAILANTS from CHARGE BANK to CHARGE]

### Step 10: Did Your Client Claim his Use of Force was Necessary to Defend a Third Party from the Complainant's Use or Attempted Use of Unlawful Force Against that Third Party?

### NO

### YES

[if YES add NON-DEADLY FORCE IN DEFENSE OF ANOTHER from CHARGE BANK to CHARGE]

### Step 11: Did Your Client Commit the Charged Conduct in an Attempt to Protect his or Another's Property?

### NO

### YES

### [if NO go to STEP 12]

### [if YES to go STEP 11A]

### Step 11A: Did the Property at Issue Belong to Your Client?

### NO

### YES

### [if NO go to STEP 11B]

### [if YES go to STEP 11C]

### Step 11B: Did the Property at Issue Belong to Another Person?

### NO

### YES

### [if YES go to STEP 11F]

### Step 11C: Did Your Client Claim he Committed the Charged Conduct in an Effort to Prevent Interference with Property in his Possession?

### NO

### YES

[if YES add NON-DEADLY FORCE IN DEFENSE OF ONE'S OWN PERSONAL PROPERTY—PREVENTING INTERFERENCE WITH PROPERTY IN ONE'S POSSESSION from CHARGE BANK to CHARGE]

### [if NO go to STEP 11D]

### Step 11D: Did Your Client Claim he Committed the Charged Conduct in an Effort to Regain Property Taken from him?

### NO

### YES

[if YES add NON-DEADLY FORCE IN DEFENSE OF ONE'S OWN PERSONAL PROPERTY—RECOVERING PROPERTY from CHARGE BANK to CHARGE]

### [if NO go to STEP 11E]

### Step 11E: Did Your Client Claim he Committed the Charged Conduct while Defending his Land or Habitation?

### NO

### YES

[if YES add NON-DEADLY FORCE IN DEFENSE OF LAND from CHARGE BANK to CHARGE]

### [if NO go to STEP 11E]

### Step 11F: Did Your Client Claim he Committed the Charged Conduct while Defending Another Person's Personal Property?

### NO

### YES

[if YES add NON-DEADLY FORCE IN DEFENSE OF THIRD PERSON'S PERSONAL PROPERTY from CHARGE BANK to CHARGE]

### Step 12: Is Your Defense that the Conduct Constituting the Assault was the Non-Volitional Result of Another Person's Act or was Set in Motion by Some Independent Nonhuman Force?

### NO

### YES

[if YES add LACK OF VOLUNTARY CONDUCT from CHARGE BANK]

### Step 13: Is Your Defense that Although Your Client Committed the Offense, as a Result of Severe Mental Disease or Defect, he Did not Know his Conduct was Wrong?

### NO

### YES

[if YES add INSANITY from CHARGE BANK]

### Step 14: Did Your Client Admit the Charged Conduct but Claim his Conduct was Immediately Necessary to Avoid Some Greater Injury to Himself or Another?

### NO

### YES

[if YES add NECESSITY from CHARGE BANK]

### Step 15: Did Your Client Claim he was Compelled to Commit the Charged Conduct by Another Who Threatened Imminent Harm or Threat of Harm to Your Client or Another if Your Client Refused?

### NO

### YES

[if YES add DURESS from CHARGE BANK to CHARGE]

### Step 16: Was Evidence of an Uncharged Bad Act [i.e. Other Crimes, Wrongs, or Bad Acts] Allowed into Evidence Against Your Client?

### NO

### YES

[if YES add LIMITED USE OF EVIDENCE—UNCHARGED “BAD ACTS” from CHARGE BANK to CHARGE]

### [if YES go to STEP 16A]

### Step 16A: Was Evidence of Multiple Uncharged Bad Acts [i.e. Other Crimes, Wrongs, or Bad Acts] Allowed into Evidence Against Your Client?

### NO

### YES

[if YES add LIMITED USE OF EVIDENCE—MULTIPLE UNCHARGED “BAD ACTS” from CHARGE BANK to CHARGE]

### Step 17: Did Your Client Testify?

### NO

### YES

[if NO add RIGHT TO REMAIN SILENT from CHARGE BANK to CHARGE]

### [if YES go to STEP 17A]

### Step 17A: Did the Court Allow the State to Introduce Evidence of Your Client's Previous Convictions, if any?

### NO

### YES

[if YES add LIMITED USE OF EVIDENCE—DEFENDANT'S PRIOR CONVICTIONS from CHARGE BANK to CHARGE]

### Step 18: Has the Trial Court Agreed to Instruct the Jury on any Presumptions that Favor the Prosecution and/or its Ability to Obtain a Conviction?

### NO

### YES

[if YES add PRESUMPTIONS FAVORING THE STATE from CHARGE BANK to CHARGE]

### Step 19: Is the Defense Claiming that a Disputed Factual Issue Calls into Question the Lawfulness of Your Client's Arrest?

### NO

### YES

[if YES add EXCLUSIONARY RULE—DISREGARD OF EVIDENCE UNLAWFULLY OBTAINED from CHARGE BANK to CHARGE]

### Step 20: Is the Defense Claiming that the Manner in which a Particular Piece of Evidence was Obtained was Unlawful or in Violation of Your Client's Rights?

### NO

### YES

[if YES add EXCLUSIONARY RULE—DISREGARD OF EVIDENCE UNLAWFULLY OBTAINED from CHARGE BANK to CHARGE]

### Step 21: Did Your Client Make any Oral or Written Statements to Law Enforcement while Under Custodial Interrogation?

### NO

### YES

### [if YES go to STEP 21A]

### [if NO go to CHARGE]

### Step 21A: Does Your Client Claim that any Oral or Written Statements Made to Law Enforcement were not Voluntarily Made?

### NO

### YES

NOTE: Article 38.21 and Article 38.22 Sec.6 of the Code of Criminal Procedure addresses the voluntariness requirement as a predicate to the admissibility of a defendant's statement. Practitioners should also be aware there are fact scenarios under a Federal Due Process analysis that might also trigger an instruction pursuant to Article 38.23 of the Code of Criminal Procedure.
[if YES add VOLUNTARINESS OF STATEMENT from CHARGE BANK to CHARGE]

### Step 21B: Does Your Client Claim that During his Custodial Interrogation he Advised Law Enforcement he Wanted an Attorney but the Interrogation was not Terminated Until Such Time as his Attorney was Present?

### NO

### YES

[if YES add RIGHT TO COUNSEL from CHARGE BANK to CHARGE]

### Step 21C: Is the Contested Evidence a Written Statement Made by the Client?

### NO

### YES

### [if NO go to STEP 21D]

[if YES add ADMISSIBILITY OF WRITTEN STATEMENT from CHARGE BANK to CHARGE]

### Step 21D: Is the Contested Evidence an Oral Recorded Statement Made by the Client?

### NO

### YES

[if YES add ADMISSIBILITY OF ORAL STATEMENT from CHARGE BANK to CHARGE]

### [go to CHARGE]

In various embodiments, the instant invention operates at its core to isolate and remove irrelevant pattern jury instructions in order to build a set of jury instructions relevant to a particular circumstance. The invention operates receive an input from a user through a questionnaire wizard and extract categorical jury instruction data from the selections which define the user input. This allows relevant definitions and jury instructions to be flagged/added to a running queue. The process then continues until either the user terminates the process by requesting an output or the user has been through the entire questionnaire wizard. A new data file is then created from the flagged definitions and jury instructions, thereby forming an output of definitions and jury instructions which only contains information relevant to the user's case information based on the user's selections.

The present invention has been shown and described herein in what is considered to be the most practical and preferred embodiment. It is recognized, however, that departures may be made therefrom within the scope of the invention and that obvious modifications will occur to a person skilled in the art.

What is claimed is:

1. A streamlined method for generating jury instructions which allows a user to skip irrelevant issues and be reminded of potentially relevant issues, comprising the steps of:
obtaining through a jury instructions wizard system a charge selection input pertinent to a selected court case in a defined legal jurisdiction, wherein the charge selection input is defined by a criminal charge at issue in the selected court case;
processing by said jury instructions wizard system said charge selection input, wherein the step of processing includes determines whether there are any culpable mental states which could potentially be at issue in the resolution of the criminal charge underlying the charge selection input, obtaining mental state selection inputs if there are any culpable mental states which could potentially be at issue, and adding to a running queue any definitions and jury instructions associated with any charge selection inputs and mental state selection inputs obtained;
obtaining through said jury instructions wizard system a transferred intent selection input and adding to the running queue any definitions and jury instructions associated with any transferred intent selection input obtained;
obtaining through said jury instructions wizard system at least one of a collaborating party selection input, a defense selection input, a special witness selection input, and an ancillary evidence selection input, wherein each of said collaborating party selection input, defense selection input, special witness selection input, and ancillary evidence selection input are obtained sequentially;
adding to the running queue any definitions and jury instructions associated with any collaborating party selection input, defense selection input, special witness selection input, and ancillary evidence selection input obtained;
providing through said jury instructions wizard system an option to output the contents of the running queue each time at least one of definitions and jury instructions are added to the running queue.

2. A streamlined method for generating jury instructions which allows a user to skip irrelevant issues and be reminded of potentially relevant issues, comprising the steps of:
obtaining through a jury instructions wizard system a charge selection input pertinent to a selected court case in a defined legal jurisdiction, wherein the charge selection input is defined by a criminal charge at issue in the selected court case;
processing by said jury instructions wizard system said charge selection input, wherein the step of processing includes determines whether there are any culpable mental states which could potentially be at issue in the resolution of the criminal charge underlying the charge selection input, obtaining mental state selection inputs if there are any culpable mental states which could potentially be at issue, and adding to a running queue any definitions and jury instructions associated with any charge selection inputs and mental state selection inputs obtained; and
providing through said jury instructions wizard system an option to output the contents of the running queue each time at least one of definitions and jury instructions are added to the running queue.

3. The streamlined method for generating jury instructions if claim 2 additionally comprising the step of obtaining through said jury instructions wizard system a transferred intent selection input and adding to the running queue any definitions and jury instructions associated with any transferred intent selection input obtained.

4. The streamlined method for generating jury instructions if claim 2 additionally comprising the step of obtaining through said jury instructions wizard system a collaborating party selection input and adding to the running queue any definitions and jury instructions associated with any collaborating party selection input obtained;

5. The streamlined method for generating jury instructions if claim 2 additionally comprising the step of obtaining through said jury instructions wizard system a defense selection input and adding to the running queue any definitions and jury instructions associated with any defense selection input obtained;

6. The streamlined method for generating jury instructions if claim 2 additionally comprising the step of obtaining through said jury instructions wizard system a special witness selection input and adding to the running queue any definitions and jury instructions associated with any special witness selection input obtained;

7. The streamlined method for generating jury instructions if claim 2 additionally comprising the step of obtaining through said jury instructions wizard system an ancillary evidence selection input and adding to the running queue any definitions and jury instructions associated with any ancillary evidence selection input obtained.

8. A streamlined method for generating jury instructions which allows a user to skip irrelevant issues and be reminded of potentially relevant issues, comprising the steps of:
obtaining through a jury instructions wizard system at least one user selection input pertinent to a selected court case in a defined legal jurisdiction, wherein wherein each of said at least one user selections is obtained through a question and answer interface; and
providing through said jury instructions wizard system an option to output the contents of the running queue each time at least one of said at least one user selections is obtained.
